(19) United States
(12) Patent Application Publication
(10) Pub. No.: US 2013/0257579 A1
(43) Pub. Date: Oct. 3, 2013

(54) HIGH-POWER FUSIBLE DEVICE

(71) Applicant: HUNG-CHIH CHIU, Taipei City (TW)

(72) Inventor: HUNG-CHIH CHIU, Taipei City (TW)

(21) Appl. No.: 13/431,988

(22) Filed: Mar. 28, 2012

(51) Int. Cl. H01H 85/04

(52) U.S. Cl. 337/161

(57) ABSTRACT

The high-power fusible device contains a main member having an upper element and a lower element as a basic structure for the high-power fusible device. The high-power fusible device further contains a fusible element positioned between the upper and lower elements, a high-thermal conductive layer sandwiched between the lower element and the fusible element, and at least a chamber on a lower side of the upper element interfacing an upper side of the fusible element as an accommodation space for the fusible element when it is blown.

### TECHNICAL FIELD OF THE INVENTION

The present invention is generally related to fuses, and more particular to a high-power fusible device.

### DESCRIPTION OF THE PRIOR ART

A conventional fusible device 30, as shown in FIG. 1, contains a fusible element 32 sandwiched between an upper element 311 and a lower element 312 of a base member 31. The upper and lower members 311 and 312 are usually made of a same material such as a ceramic material. This conventional structure does not have any high-thermal or low-thermal conductive layer, and therefore cannot sustain a high power or be applied in a circuit of a large current. In addition, there is no appropriate thermal conduction design which is important for protecting the fusible device or other electronic elements of a protection circuit. These would bring inconvenience and difficulty to the user.

### SUMMARY OF THE INVENTION

Therefore, a novel high-power fusible device is provided herein which contains a main member having an upper element and a lower element as a basic structure for the high-power fusible device. The high-power fusible device further contains a fusible element positioned between the upper and lower elements, a high-thermal conductive layer sandwiched between the lower element and the fusible element, and at least a chamber on a lower side of the upper element interfacing an upper side of the fusible element as an accommodation space for the fusible element when it is blown.

Preferably, the upper and lower elements are made of a ceramic material.

Alternatively, a low-thermal conductive layer is configured on an upper side of the upper element.

Alternatively, a high-thermal conductive layer is configured on an upper side of the upper element.

Another high-power fusible device of the present invention contains a main member having an upper element and a lower element as a basic structure for the high-power fusible device. The high-power fusible device further contains a fusible element sandwiched between the upper and lower elements, a high-thermal conductive layer configured on a lower side of the lower element, and at least a chamber on a lower side of the upper element interfacing an upper side of the fusible element as an accommodation space for the fusible element when it is blown.

Preferably, the upper and lower elements are made of a ceramic material.

Alternatively, a low-thermal conductive layer is configured on an upper side of the upper element.

Alternatively, a high-thermal conductive layer is configured on an upper side of the upper element.

A major objective of the present invention is to provide a fusible device capable of sustaining a high power.

Another objective of the present invention is to provide a fusible device capable of protecting a fusible element.

Yet another objective of the present invention is to provide a fusible device capable of protecting other electronic components.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional fusible device.

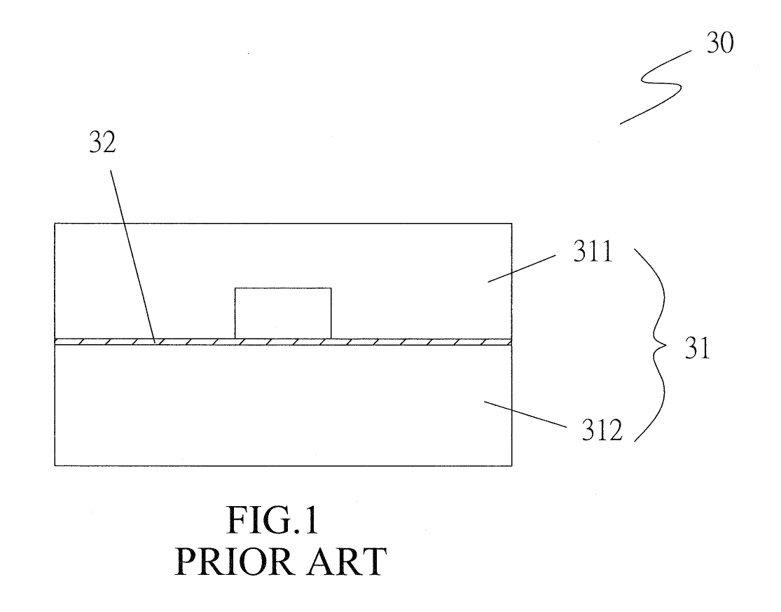

FIG. 2 is a schematic diagram showing a high-power fusible device according to a first embodiment of the present invention.

FIG. 3 is a schematic diagram showing a high-power fusible device according to a second embodiment of the present invention.

FIG. 4 is a schematic diagram showing a high-power fusible device according to a third embodiment of the present invention.

FIG. 5 is a schematic diagram showing a high-power fusible device according to a fourth embodiment of the present invention.

FIG. 6 is a schematic diagram showing a high-power fusible device according to a fifth embodiment of the present invention.

FIG. 7 is a schematic diagram showing a high-power fusible device according to a sixth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

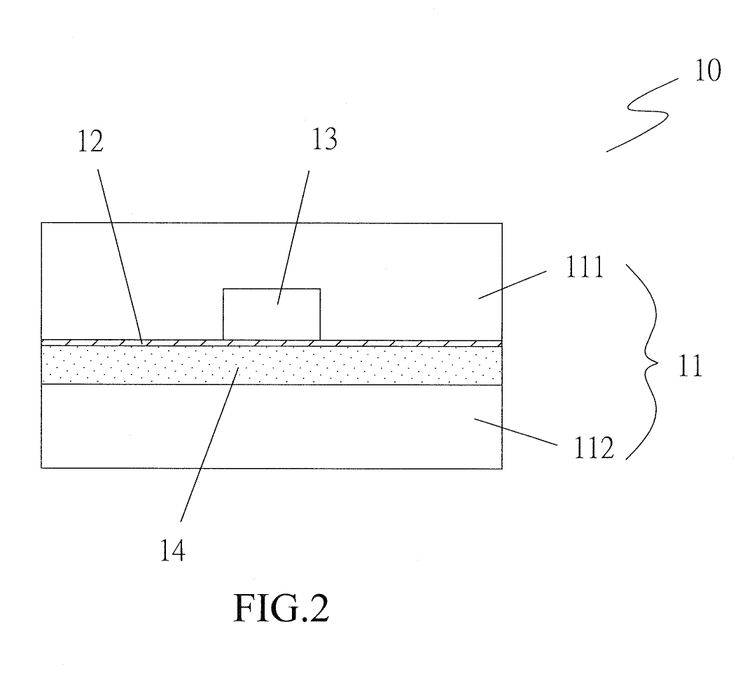

As shown in FIG. 2, a high-power fusible device 10 according a first embodiment of the present invention contains a main member 11 having an upper element 111 and a lower element 112 as a basic structure for the high-power fusible device 10. The high-power fusible device 10 further contains a fusible element 12 positioned between the upper and lower elements 111 and 112, a high-thermal conductive layer 14 sandwiched between the lower element 112 and the fusible element 12, and at least a chamber 13 on a lower side of the upper element 111 interfacing an upper side of the fusible element 12 as an accommodation space for the fusible element 12 when it is blown. The upper and lower elements 111 and 112 are made of a ceramic material.

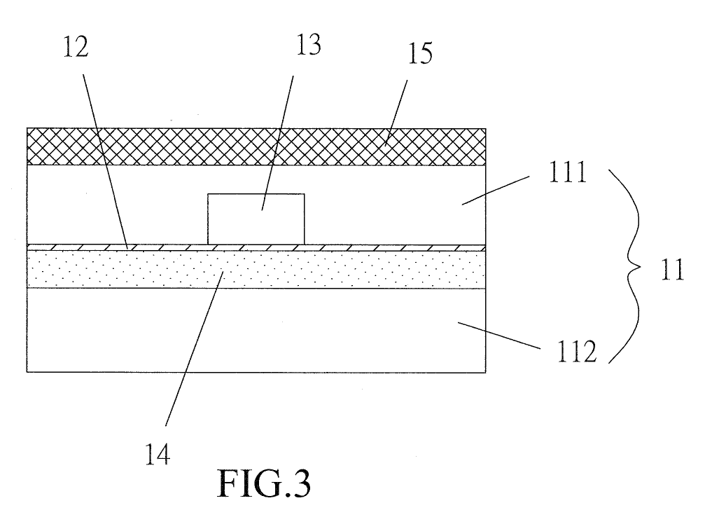

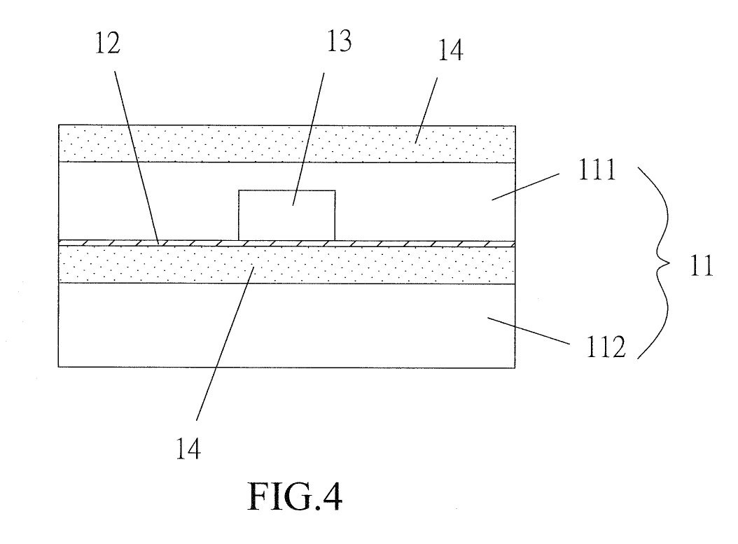

FIGS. 3 and 4 depict a second embodiment and a third embodiment of the present invention. As illustrated in FIG. 3, the high-power fusible device 10 of the second embodiment is further configured with a low-thermal conductive layer 15 on an upper side of the upper element 111, whereas the high-power fusible device 10 of the third embodiment shown in FIG. 4 is further configured with a high-thermal conductive layer 14.

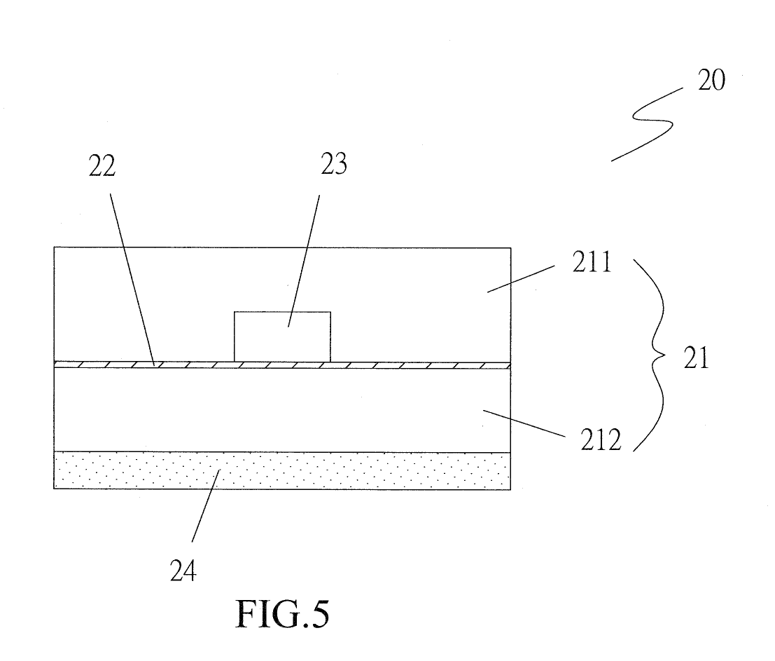

As shown in FIG. 5, a high-power fusible device 20 according a fourth embodiment of the present invention contains a main member 21 having an upper element 211 and a lower element 212 as a basic structure for the high-power fusible device 20. The fusible device 20 further contains a fusible element 22 sandwiched between the upper and lower elements 211 and 212, a high-thermal conductive layer 24 on a lower side of the lower element 212, and at least a chamber 23 on a lower side of the upper element 111 interfacing an upper side of the fusible element 22 as an accommodation space for the fusible element 22 when it is blown. The upper and lower elements 211 and 212 are made of a ceramic material.

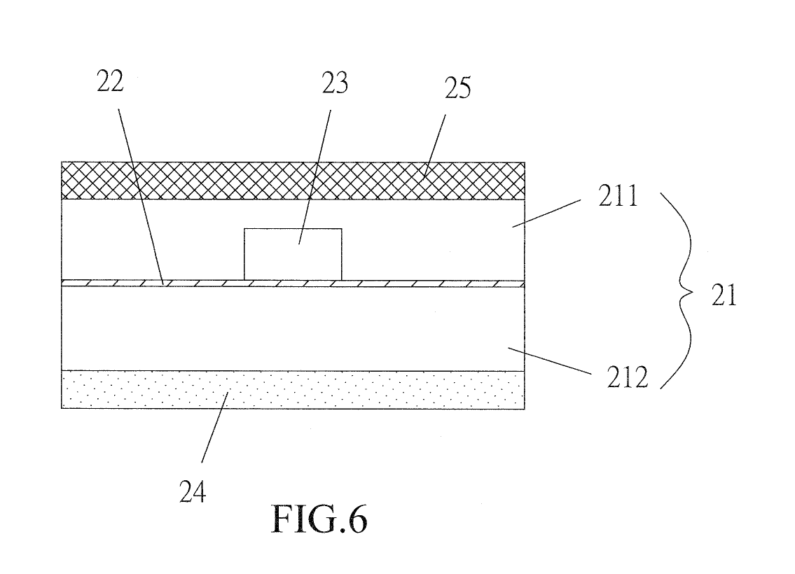

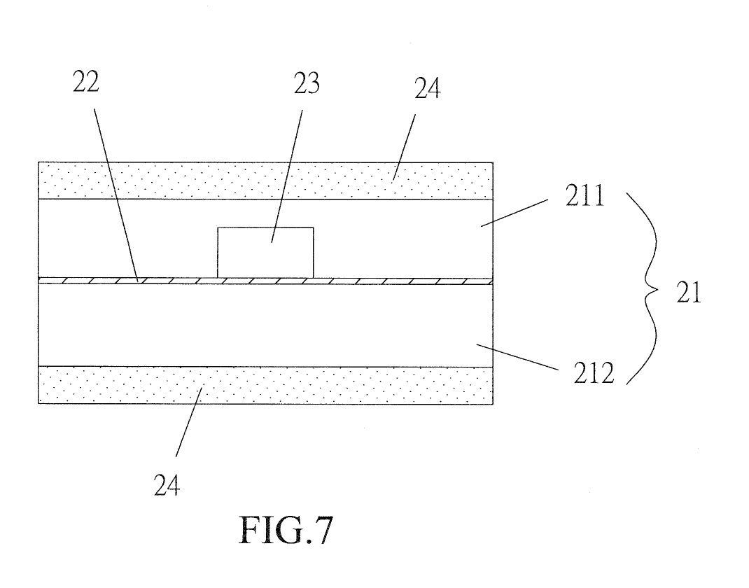

FIGS. 6 and 7 depict a fifth embodiment and a sixth embodiment of the present invention. As illustrated in FIG. 6, the high-power fusible device 20 of the fifth embodiment is further configured with a low-thermal conductive layer 25 on an upper side of the upper element 211, whereas the high-power fusible device 20 of the sixth embodiment shown in FIG. 7 is further configured with a high-thermal conductive layer 24.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high-power fusible device, comprising:
a main member having an upper element and a lower element as a basic structure for the high-power fusible device;
a fusible element positioned between the upper and lower elements;
a high-thermal conductive layer sandwiched between the lower element and the fusible element; and
at least a chamber on a lower side of the upper element interfacing an upper side of the fusible element as an accommodation space for the fusible element when it is blown.

2. The high-speed connector according to claim 1, wherein the upper and lower elements are made of a ceramic material.

3. The high-speed connector according to claim 1, further comprising a low-thermal conductive layer on an upper side of the upper element.

4. The high-speed connector according to claim 1, further comprising a high-thermal conductive layer configured on an upper side of the upper element.

5. A high-power fusible device, comprising:
a main member having an upper element and a lower element as a basic structure for the high-power fusible device;
a fusible element sandwiched between the upper and lower elements;
a high-thermal conductive layer on a lower side of the lower element; and
at least a chamber on a lower side of the upper element interfacing an upper side of the fusible element as an accommodation space for the fusible element when it is blown.

6. The high-speed connector according to claim 5, wherein the upper and lower elements are made of a ceramic material.

7. The high-speed connector according to claim 5, further comprising a low-thermal conductive layer on an upper side of the upper element.

8. The high-speed connector according to claim 5, further comprising a high-thermal conductive layer configured on an upper side of the upper element.
